(19) United States
(12) Patent Application Publication
(10) Pub. No.: US 2010/0215432 A1
(43) Pub. Date: Aug. 26, 2010

(54) BLOCK EQUIPPED WITH DRAINAGE AND VENTILATION FUNCTION, ITS PRODUCING METHOD, AND BLOCK MULT-LAYER FORMED FROM MATERIALIZATION OF THE BLOCKS

(76) Inventors: Heung Sik Yu, Namyangju-si (KR); Seong Kyun Jin, Seoul (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/599,051

(22) PCT Filed: May 15, 2007
(86) PCT No.: PCT/KR2007/002366

§ 371 Date: Nov. 6, 2009

(30) Foreign Application Priority Data
May 8, 2007 (KR) 10-2007-0044396

(51) Int. Cl. E01C 11/24; E04C 1/39; E04C 1/40; E04C 1/41; E04B 1/38; B29C 33/42

(52) U.S. Cl. 404/72; 52/503; 52/309.1; 52/606; 52/588.1; 264/337

(57) ABSTRACT

The invention provides blocks made of certain material, equipped with drainage and ventilation functions, and a side of the blocks formed with first interlocking part and second interlocking part in the opposite but corresponding side while other two sides without the interlocking part formed with ventilating channels penetrating the center of the block unit and other areas without first and second interlocking parts equipped with chamfered channels in certain length and width. The blocks of the invention are paved in multi-layers and equipped with numerous ventilation channels and longitudinal grooving. Thus, the multi-layer structure provides sound drainage of water and moisture while preventing subsidence of road via maximizing the maintenance period of the pavement.

### TECHNICAL FIELD

The invention relates to blocks equipped with drainage and ventilation functions, block producing method, and multi-layer paving method utilizing these blocks, particularly, by forming interlocking part in each but corresponding sides of the blocks while other upper surface formed with certain size longitudinal chamfering in multiple lines apart from each other by certain width yet another side formed with ventilating channels that penetrate the center of the block unit made of specific material, thus, the interlocking part of a block unit locks with the another block unit that is equivalent in shape and dimension to pave multi-layer block pavement.

### BACKGROUND ART

Unlike the past, with the improvements of lifestyles and increasing concerns about the environment the beauty aspect of the building structures as been emphasized as well as the environmentally friendly issue. In addition, there are increased concern for more advanced and improved road pavements that demand both the safety and beauty aspect in highways, bus lanes, bicycle lanes, and school zones. Among these paving methods concrete slab, asphalt, and block paving are popular. For the above methods, cement and asphalt are one of the well used materials for paving as well as the building structures.

Referring to FIG. 1 of the conventional pavements, the over all process of the construction is; leveling and compaction of the subgrade/ground followed by compaction of the gravel subbase step (S100), pave concrete blocks on a prepared subbase in paving step (S200), leveling job with fixations of blocks or gravel using cement mortar in the levelling step (S300), preparing sand bed on a leveled surface and fill the gaps between the adjacent blocks with sand in the block paving step (S400).

As in detail, the initial step of the conventional road construction method involves leveling and compaction of the subgrade/ground followed by the construction of the subbase. Secondly, blocks are paved on the prepared subbase followed by leveling of the blocks by filling the gaps of the adjacent blocks using cement mortar. Moreover, as mentioned previously, sand bed is formed on the leveled or prepared surface followed by filling the gaps of the adjacent blocks using sand to complete road pavement.

However, with the conventional method, the cost involved with cement mortar application, long term construction period, and vibration and noise due to transverse gaps between the blocks that account for bad drivability resulted as an ineffective solution for road construction purpose. Thus, the conventional block paving method has rather been used widely for sidewalks. However, the adverse weather condition such as frost and frequent heavy load traffic access resulted in further damages to the pavement and severe deformation.

The above conventional methods, in particular, had problems with moisture that normally built up from the lower layers of pavement while the impermeable surface layer stopped the moisture from being evaporated. Since the use of gravel for the base and subbase course, the density of the material used for the lower layers increased due to the compaction, thus, providing poor ventilation and consequently promoting the moisture to remain in the layers. Therefore, although both drainage and sewer channels has been utilized in order to improve the drainage effect of rainwater, these conventional methods were inefficient in conditions such as soft ground and low areas. The costly reinforcement methods for such conditions promoted deterioration of mountains in order to obtain enormous amount of gravel yet resulted in some countries with scarcity of gravel difficult to build roads.

### DISCLOSURE

### Technical Problem

The invention has a purpose to provide solutions to the above problems faced by the conventional methods. Since, the blocks with number of drainage channels and longitudinal grooving provide sound drainage of water and moisture, the multi-layer prevents subsidence of road while maximizing the maintenance period of the pavement. The invention provides blocks equipped with drainage and ventilation function, block producing method, and multi-layer paving method utilizing these blocks.

In addition, since the invention does not require utilization of gravel for lower layers of the pavement, it is unnecessary for deterioration of mountains for obtaining gravel. Therefore, it is highly environmentally friendly to pave multi-layered roads utilizing blocks equipped with drainage and ventilation function.

### Technical Solution

As a means of achieving the above purpose the invention provides blocks made of certain material, equipped with drainage and ventilation functions, and both sides of the block formed with the first interlocking part and second interlocking part in the opposite but corresponding sides while other two sides without the interlocking part formed with ventilating channels penetrating the center of the block unit.

Other features of the invention include screening step of screening of the impurities from the soil to be used for road construction;

agitating step followed by screening step where mixed soil material is well mixed in a mixing batch;

block forming step where blocks made of soil rock mix component is formed by placing the agitated mix material into a steel mold;

curing step followed by block forming step where the blocks formed are cured in order to produce soil rock based blocks in a certain shape and size while equipping the blocks with drainage and ventilation functions.

Other features of the invention include cement agitating step of mixing concrete based constituents in a mix batch;

After the cement agitating step, the invention provides blocks made of cement material equipped with drainage and ventilation function and its producing method, which includes the producing process of curing and forming cement blocks in a steel mold in order to make the block equipped with ventilation channels and interlocking part in a shape of alphabet letter “S”.

Other features of the invention are about leveling the ground step that involves leveling and compaction of the subgrade/ground;

sand spreading step which involves spreading sandbed in certain thickness on a prepared subgrade/ground;

The first mat applying step which involves covering the sandbed with special mat on a prepared sandbed in the sand spreading step;

soil rock block paving step which involves continually interlinking first interlocking part with second soil rock block interlocking part on a prepared mat in the first mat applying step;

The second mat applying step which involves covering the soil rock block surface with another type of special mat;

cement block paving step which involves continually interlinking first interlocking part to second interlocking part of the cement block units on a prepared mat in the second mat applying step.

On the other hand, other features of the invention are about leveling the ground step that involves leveling and compaction of the subgrade/ground;

soil rock block paving step which involves continually interlinking first interlocking part to second interlocking part of the soil rock block units on a prepared subgrade/ground;

asphalt paving step which involves paving on a prepared soil rock block surface with asphalt for providing road construction method utilizing blocks equipped with drainage and ventilation functions.

Other features of the invention are about leveling the ground step that involves leveling and compaction of the subgrade/ground;

gravel spreading step followed by the levelling the ground step, which involves spreading coarse gravel base in a certain thickness with minimized voids and in an uniform manner on a prepared subgrade/ground;

base formation step followed by the gravel spreading step which involves spreading less-coarse gravel base in certain thickness with minimized voids and in an uniform manner on a prepared coarse gravel base;

cement block paving step which involves continually interlinking first interlocking part to second interlocking part of cement blocks on a prepared less-coarse gravel base.

In addition to the above features, the other features of the invention are about levelling the ground step which involves levelling and preparing ground/subgrade;

First mat applying step which involves covering the prepared ground/subgrade with a certain type of special mat;

First subsurface soil rock block paving step which involves continually interlinking first interlocking part to second interlocking part of soil rock block units on a prepared mat in the first mat applying step;

Second mat applying step which involves covering the first soil rock block surface with another type of special mat;

Second subsurface soil rock block paving step which involves continually interlinking first interlocking part to second interlocking part of soil rock block units on a prepared mat in the second mat applying step;

Third mat applying step which involves covering the second subsurface soil rock block surface with another type of special mat;

Cement block paving step which involves continually interlinking first interlocking part to second interlocking part of cement block units on a prepared mat in the third mat applying step.

### ADVANTAGEOUS EFFECTS

The blocks of the invention are paved in multi-layers and equipped with numerous ventilation channels and longitudinal grooving. Thus, the multi-layer structure provides sound drainage of water and moisture while preventing subsidence of road via maximizing the maintenance period of the pavement.

In addition, since the invention does not require utilization of gravel for lower layers of the pavement yet utilize soil rock block for the subsurface layers in a multi-layer construction and utilize cement block as a surface layer, it is unnecessary to deteriorate mountains for obtain gravel.

Therefore, it is highly effective in constructing environmentally friendly roads.

### DESCRIPTION OF FIGURES

FIG. 1 is a flow chart that illustrates the conventional road construction method.

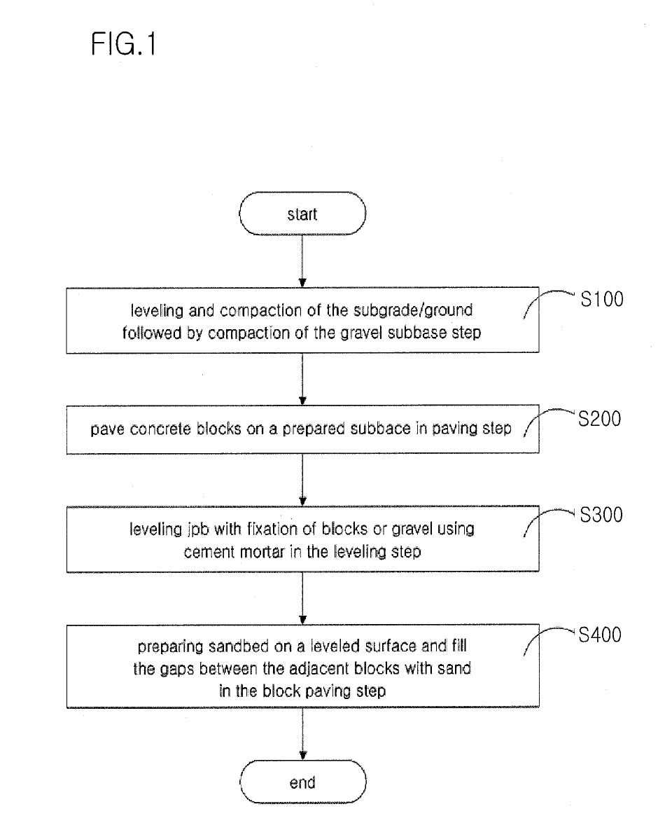

FIG. 2 illustrates a sample block of the invention.

FIG. 3 illustrates another sample block of the invention.

FIG. 4 is a flow chart that illustrates the soil rock block producing method of the invention.

FIG. 5 is a flow chart that illustrates the cement block producing method of the invention.

FIG. 6 is a flow chart that illustrates the road construction method utilizing the invented blocks.

FIG. 7 illustrates a sample of FIG. 6.

FIG. 8 is a flow chart that illustrates second road construction method utilizing the invented blocks.

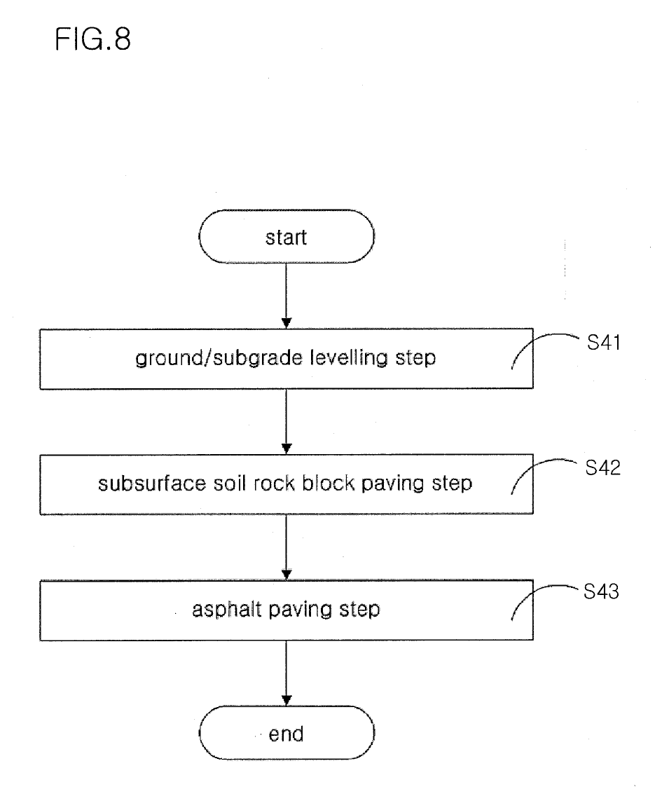

FIG. 9 illustrates a second sample of FIG. 8.

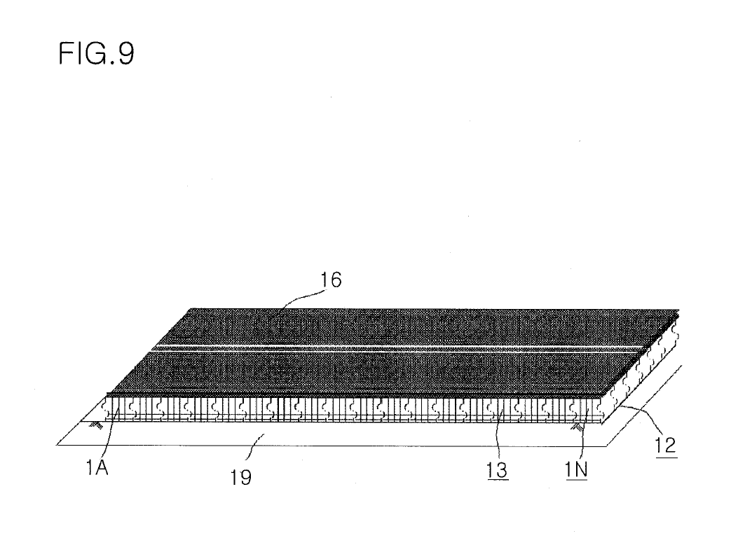

FIG. 10 is a flow chart that illustrates third road construction method utilizing the invented blocks.

FIG. 11 illustrates a third sample of FIG. 10.

FIG. 12 is a flow chart that illustrates fourth road construction method utilizing the invented blocks.

FIG. 13 illustrates a fourth sample of FIG. 12.

FIG. 14 illustrates the difference between banking method of the invention and the conventional road construction method.

### BEST MODE

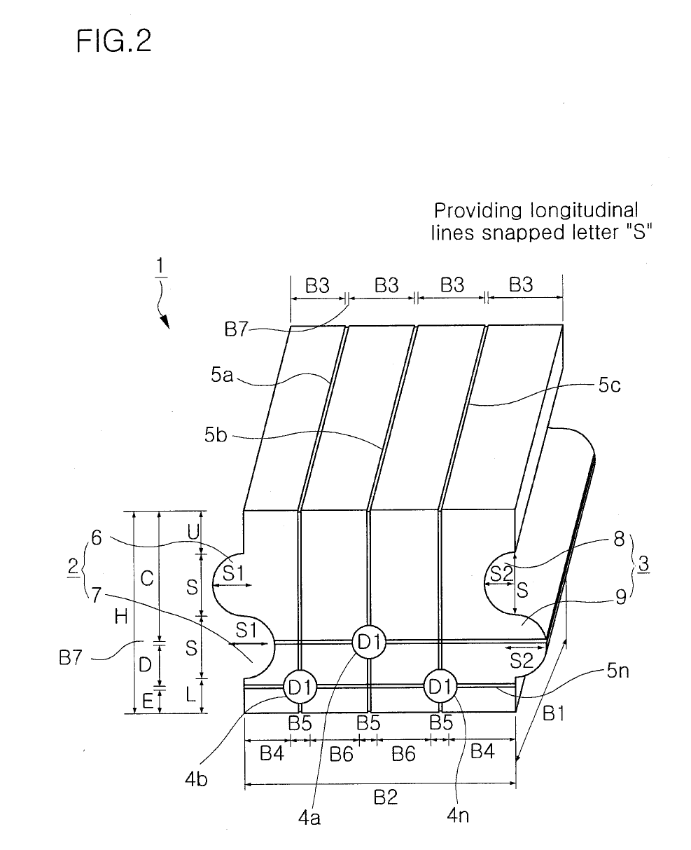

According to the detailed explanation of embodyments in the attached figures, in FIG. 2, the block (1,1A-N) of the invention is about the first interlocking part (2) and second interlocking part (3) in each but corresponding sides of the blocks while other sides without the interlocking parts are formed with ventilating channels (4a-n) that penetrate the center of the block unit made of specific material.

In this position, the block (1,1A-N) of the invention is about the first interlocking part (2) and second interlocking part (3) in each but corresponding sides of the blocks while other two surfaces formed with longitudinal grooving (5a-n) of certain size in multiple lines apart from each other by certain width.

The invented block (1,1A-N)s can be produced utilizing different materials e.g. concrete, soil, soil rock component, synthetic rock, wood, polyester, polymer, ceramic, rubber, steel, metal, polyurethane, chemi-petrolium compound, and plastic.

On the other hand, invented block (1,1A-N)s are utilized in order to pave roads by interlinking first interlocking part (2) of block (1A) with second interlocking part (3) of block (1B).

### MODE FOR INVENTION

The following embodyments of the invention in detail.

### Embodyment 1

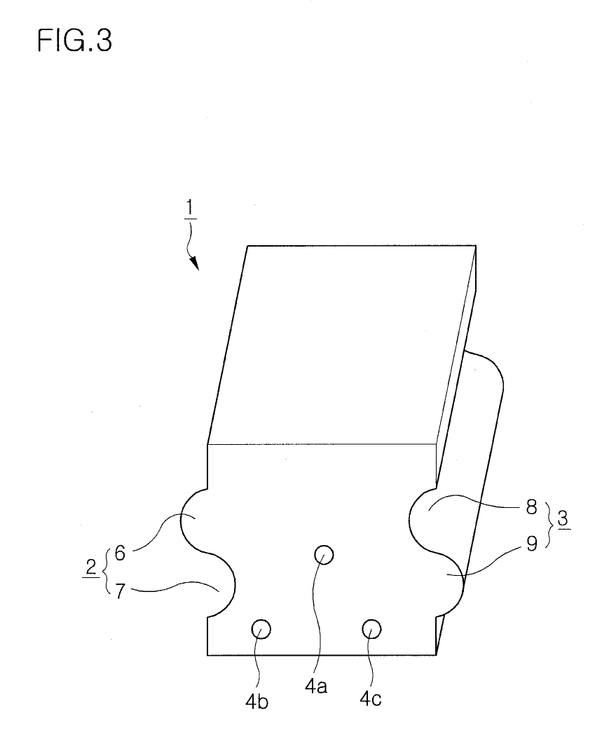

As illustrated in FIG. 3, first interlocking part (2) of a block (1) is shaped in an alphabet letter “S” and second interlocking part (3) of reverse letter “S” shape on the opposite but corresponding side while other sides without the interlocking parts are formed with ventilating channels (4a-n) that penetrate the center of the block unit.

In other words, semi-circular shape of the first projecting section (5) is formed on the upper section of the first interlocking part (2) and first grooved section (6) located below in a semi-circular shape. Moreover, semi-circular shape of second grooved section (7) is formed on the upper section of the second interlocking part (3) and second projecting section (8) located below in a semi-circular shape.

### Embodyment 2

As illustrated in FIG. 2, first interlocking part (2) of a block (1) is shaped in an alphabet letter “S” located and second interlocking part (3) of reverse letter “S” shape on the corresponding but opposite side while other sides are formed with ventilating channels (4a-n) that penetrate the center of the block unit. However, the other two surfaces without the interlocking parts are formed with longitudinal grooving (5a-n) of certain size in multiple lines apart from each other by certain width and shaped in an alphabet letter “U”.

In other words, semi-circular shape of first projecting section (5) is formed on the upper section of the first interlocking part (2) and first grooved section (6) located below also in a semi-circular shape. Moreover, semi-circular shape of second grooved section (7) is formed on the upper section of the second interlocking part (3) and second projecting section (8) located below also in a semi-circular shape.

Here, like what has been indicated in Table 1, the dimensions of the above block (1,1A-N) varies depending on the strength requirement of the roads.

TABLE 1
Dimension of the invented blocks
equipped with drainage and ventilation function

| [symbol] | H | B1 | B2 | B3 | B4 | B5 | B6 | B7 | C | D | D1 | E | L | U | S | S1 | S2 |
|---|---|---|---|---|---|---|---|---|---|---|---|---|---|---|---|---|---|
| 150 × 150 × | 100 | 150 | 150 | 34.5 | 32.5 | 10 | 27.5 | 6 | 57 | 14.5 | 10 | 25 | 30 | 30 | 20 | 10 | 10 |
| 100 | | | | | | | | | | | | | | | | | |
| 150 × 150 × | 120 | 150 | 150 | 34.5 | 32.5 | 10 | 27.5 | 6 | 69.5 | 16.5 | 10 | 26 | 35 | 35 | 25 | 12.5 | 12.5 |
| 120 | | | | | | | | | | | | | | | | | |
| 200 × 200 × | 150 | 200 | 200 | 44 | 44 | 12 | 38 | 8 | 86.5 | 23.5 | 12 | 28 | 40 | 40 | 35 | 17.5 | 17.5 |
| 150 | | | | | | | | | | | | | | | | | |
| 200 × 200 × | 200 | 200 | 200 | 44 | 44 | 14 | 38 | 8 | 121 | 27 | 14 | 36 | 50 | 50 | 50 | 25 | 25 |
| 200 | | | | | | | | | | | | | | | | | |
| 250 × 250 × | 180 | 250 | 250 | 55.5 | 55.5 | 14 | 48.5 | 10 | 107.5 | 31.5 | 14 | 30 | 45 | 45 | 45 | 22.5 | 22.5 |
| 180 | | | | | | | | | | | | | | | | | |
| 250 × 250 × | 250 | 250 | 250 | 54.5 | 54.5 | 16 | 46.5 | 10 | 151.25 | 31.5 | 16 | 47.5 | 62.5 | 62.5 | 62.5 | 31.25 | 31.25 |
| 250 | | | | | | | | | | | | | | | | | |
| 300 × 300 × | 200 | 300 | 300 | 69 | 68 | 12 | 48.5 | 12 | 121 | 35.5 | 14 | 34 | 50 | 50 | 50 | 25 | 25 |
| 200 | | | | | | | | | | | | | | | | | |
| 300 × 300 × | 250 | 300 | 300 | 69 | 67 | 16 | 46.5 | 12 | 150.25 | 35.5 | 16 | 45.5 | 62.5 | 62.5 | 62.5 | 31.25 | 31.25 |
| 250 | | | | | | | | | | | | | | | | | |
| 300 × 300 × | 300 | 300 | 300 | 69 | 65 | 20 | 42.5 | 12 | 181.5 | 35.5 | 20 | 59 | 75 | 75 | 75 | 37.5 | 37.5 |
| 300 | | | | | | | | | | | | | | | | | |

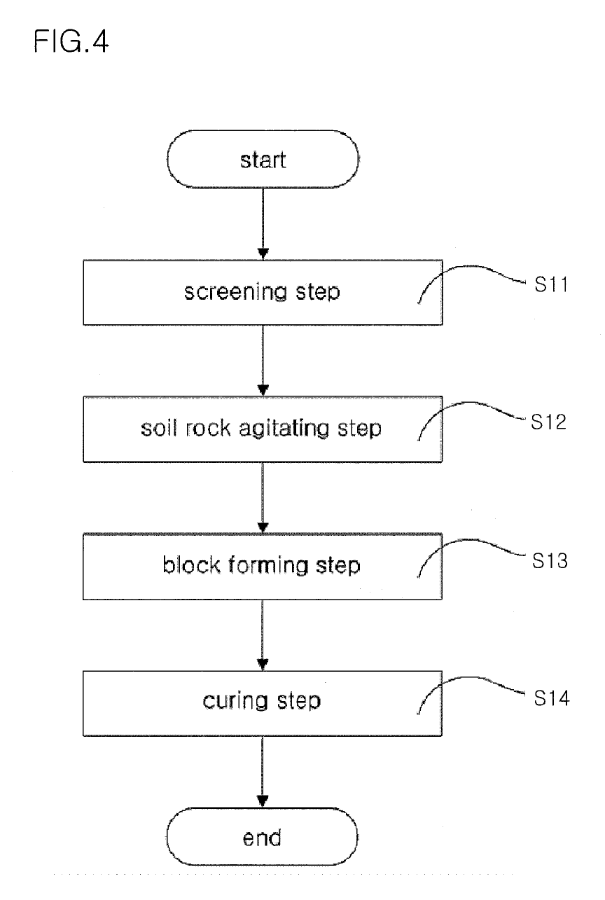

On the other hand, as outlined in FIG. 4, another embodyment of the producing method of the blocks made of soil rock material includes screening step (S11) of screening the impurities such as roots and gravel of sieve size 20 mm or over.

After the screening step (S11), soil rock agitating step (S12) is followed in order to mix the soil rock based constituents well in a mix batch. In addition, block forming step (S13) followed by soil rock agitating step (S12) is processed in order to form blocks in a steel mold.

The blocks produced in a steel mold during the block forming step (S13), as illustrated in FIG. 2, have the side areas formed with ventilating channels that penetrate the center of the block unit with letter “S” shape on a side or as illustrated in FIG. 3, have two surfaces of the interlocking block unit formed with longitudinal grooving with letter “S” shape on a side.

One of the sample mix ratio of producing the blocks in soil rock agitating step (S12) are; 85 weight % soil, 5 weight % cement, 3 weight % emulsion, 7 weight % water.

If there are insufficient amount of materials such as less than 5 weight % cement and 3 weight % emulsion in the soil rock agitating step (S12), the compressive strength of the block decreases while less emulsion results in reduced impermeable and water resistance effects. On the other hand, if there are more than enough materials mixed such as over 5 weight % cement and 3 weight % emulsion in the soil rock agitating step (S12), the compressive strength of the block increases but the cost rise and elasticity reduces. Therefore, it is recommended to apply specified amount, which is 5 weight % cement and 3 weight % emulsion.

The curing step (S14) includes but not limited to 10 days curing, outdoor, however, prevent the exposure to direct sunlight by covering the blocks with vinyl or textiles and maintaining 60 weight % humidity for 7 days followed by 3 day indoor curing. Moreover, the indoor curing facility must be regulated so that the temperature remains under 70 maximum.

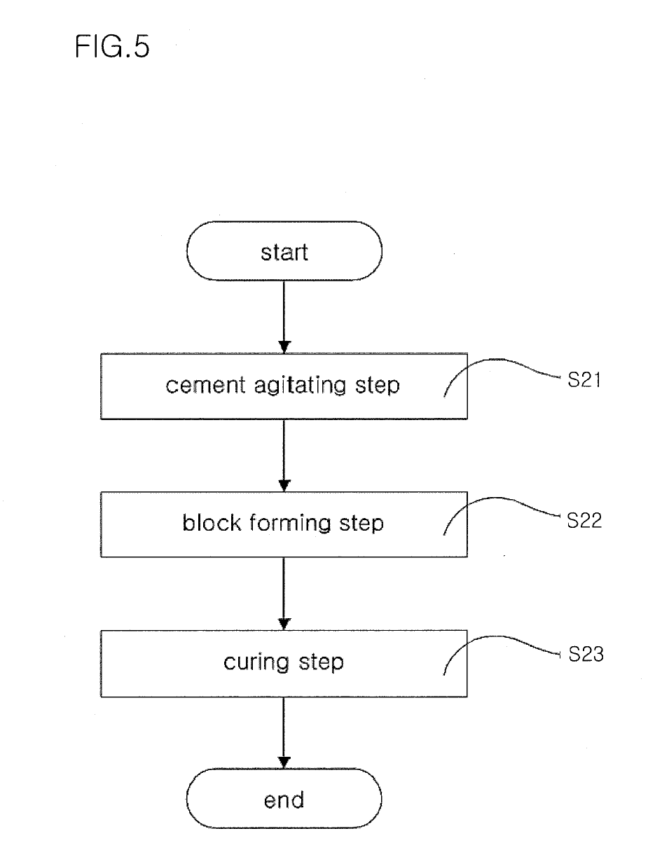

On the other hand, another method of block producing includes but not limited to producing cement blocks, as illustrated in FIG. 5. Cement agitating step (S21) is followed in order to mix the cement based constituents well in a mix batch. In addition, block forming step (S22) followed by cement agitating step (S21) is proceeded in order to form blocks in a steel mold.

Furthermore, followed by the block forming step (S22), curing step (S23) is followed in order to cure and produce blocks in a certain size.

The blocks produced in a steel mold during the block forming step (S22), as illustrated in FIG. 2, have two side areas formed with ventilating channels that penetrate the center of the block unit with letter “S” shape on other sides or as illustrated in FIG. 3, a side of the block unit formed with longitudinal grooving on the other side.

One of the sample mix ratio of producing the blocks in cement agitating step (S21) is; 42 weight % fine sand, 37 weight % coarse sand, 14 weight % cement, and 7 weight % water.

In addition, in the curing step (S23), blocks are cured under sunlight, however, blocks need frequent watering in order to prevent rapid drying and stiffening. Moreover, temperature change step is provided in order to prevent rapid change of temperature (within 20/h). In addition, temperature regulating step is provided in order to prevent the maximum temperature from rising over 65.

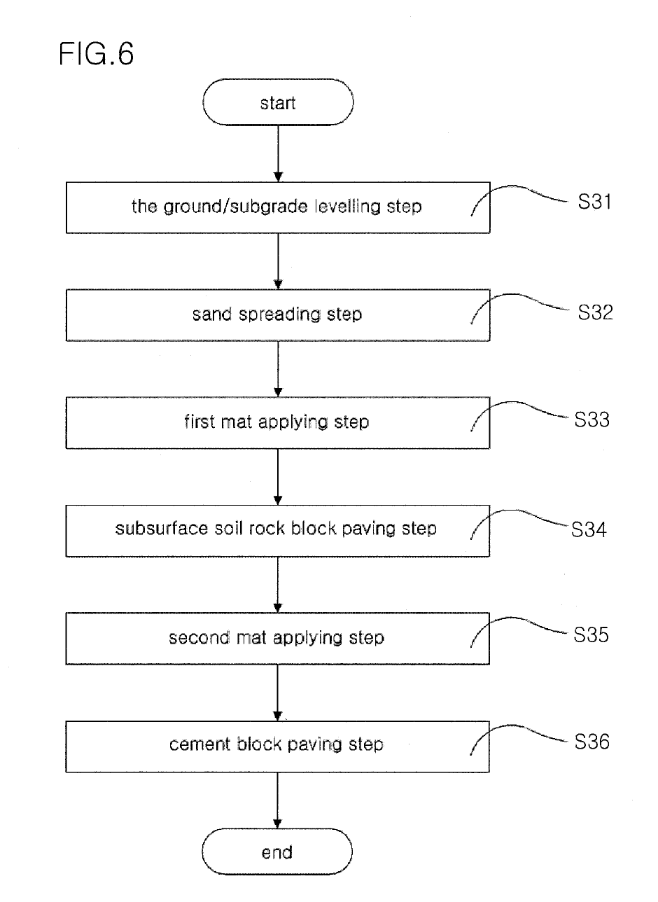

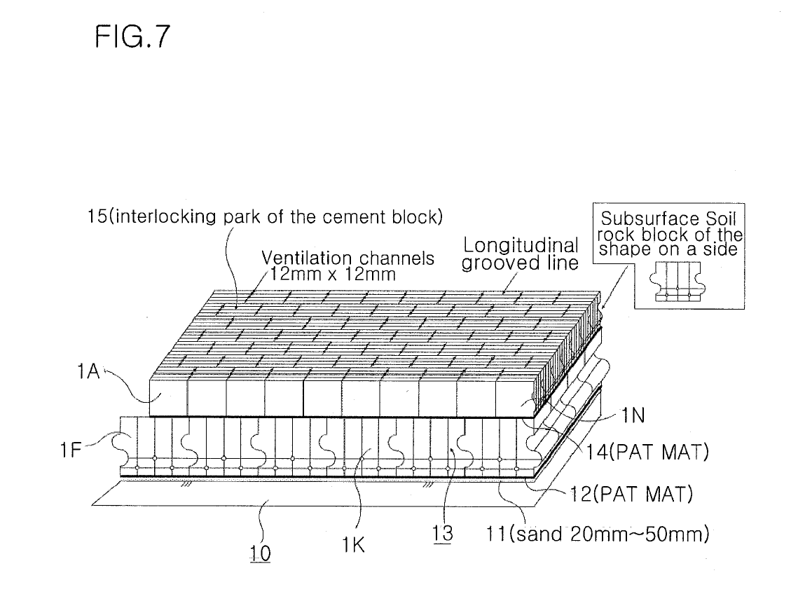

One of the sample road construction method of the invention, as illustrated in FIG. 6 and FIG. 7, involves levelling the ground/subgrade (10). After the sand spreading step (S32) first mat applying step (S33) is followed, which involves covering the prepared sandbed with a certain type of special mat. On the other hand, after the first mat applying step (S33), first subsurface soil rock block paving step (S34) is followed, which involves continually interlinking first interlocking part to second interlocking part of the subsurface soil rock block (13) on a prepared mat (12) in first mat applying step.

After the paving step (S34) that utilizes subsurface soil rock block (13), second mat applying step (S35) is followed in order to cover the surface of the subsurface soil rock block (13) with another type of special mat (14). After the second mat applying step (S35), cement block paving step (S36) is followed, continually interlinking first interlocking part to second interlocking part of the cement block (15) on a prepared second mat (14).

Here, the thickness of the sandbed (11) in the sand spreading step (S32) is about 20 mm ˜50 mm. In addition, the special type of mat in the first mat applying step (S33) and second mat applying step (S35) is PAT MAT (11) made of materials such as polyester, polymer, nylon, synthetic textile (made of material with reasonable drainage and ventilation effect).

Furthermore, the above subsurface (13) in the subsurface soil rock block paving step (S34) includes base, subbase, and anti-frost layer.

One of the sample road paving methods in subsurface soil rock block paving step (S34) and cement block paving step (S36) involves interlinking blocks (1,1A-1N) such as first interlocking part (2) of block (1B) with second interlocking part (3) of block (1A) on a mat (12). In other words, to insert first projecting section (5) of first interlocking part (2) of block (1B) with second grooved section (7) of the block (1A), the first grooved section (6) below first projecting section (5) of first interlocking part (2) of block (1B) interlinks with second projecting section (8) of the other block (1A). Therefore, the overall shape of the interlocked blocks are solid structure like a screw-type. Moreover, while the blocks (1,1A-1N) are continually interlocked to each other the remaining two sides without first interlocking part (2) and second interlocking part (3) have adjoining ventilation channels (4a-n) that creates a channel to drain the rainwater.

Therefore, the water is passed through the gaps of the blocks (1,1A-1N) via passed through the channels formed by adjoining block (1,1A-1N) units and so water passes through the channels provided by the ventilation channel (4a-n) while air circulates.

One of the sample road paving methods in subsurface soil rock block paving step (S34) and cement block paving step (S36) involves interlinking blocks (1,1A-1N) such as first interlocking part (2) of block (1B) with second interlocking part (3) of block (1A) on a mat (12). while the blocks (1,1A-1N) are continually interlocked to each other and the side dimensions of the blocks are equal, thus, providing longitudinal lines shaped letter “U”, which is also a channel of grooving (5a-n).

Therefore, to insert first projecting section (6) of block (1B) with second grooved section (8) of block (1A), the first grooved section (7) below first projecting section (6) interlinks with second projecting section (9) of the other block (1A). Since, the first interlocking part (2) interlinks with the second interlocking part (3) of the block (1,1A-1N) units, the overall shape of the interlocked blocks are solid structure like a screw-type. Moreover, while the blocks (1,1A-1N) are continually interlocked to each other the remaining two sides without first interlocking part (2) and second interlocking part (3) have adjoining ventilation channels (4a-n) that creates a channel to drain the rainwater.

The blocks (1,1A-1N) are continually interlocked to each other and the side dimensions of the blocks are equal, thus, providing longitudinal lines shaped letter “U” of the block units meets with each other to form a long channel of grooving (5a-n). These grooving (5a-n) will make the road surface look with numerous longitudinal grooved lines.

Therefore, in a heavy rain or flooding condition, the rainwater flows through the channels provided by the grooving (5a-n) and passed through the ventilation channel (4a-n) formed between the adjoining blocks (1,1A-1N).

Second sample road construction method of the invention, as illustrated in FIG. 6 and FIG. 7, involves levelling the ground/subgrade step (S41). After the levelling the ground/subgrade step (S41), subsurface soil rock block paving step (S42) is proceeded, which involves continually interlinking first interlocking part to second soil rock block interlocking part of the subsurface soil rock block.

Moreover, after the subsurface soil rock block paving step (S42), asphalt paving step (S43) is proceeded to pave asphalt surface on soil rock block surface.

One of the sample road paving methods in subsurface soil rock block paving step (S42) involves interlinking blocks (1,1A-1N) such as first interlocking part (2) of block (1B) with second interlocking part (3) of block (1A) on a mat (12). In other words, to insert first projecting section (5) of block (1B) with second grooved section (7) of block (1A), the first grooved part (6) below first projecting section (5) of first interlocking part (2) of block (1B) interlinks with second projecting section (8) of the other block (1A). Therefore, the overall shape of the interlocked blocks are solid structure like a screw. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

Therefore, the water is passed through the gaps of the blocks (1,1A-1N) via passed through the channels formed by adjoining block (1,1A-1N) units and so water passes through the channels provided by the ventilation channel (4a-n) while air circulates.

One of the sample road paving methods in subsurface soil rock block paving step (S42) involves interlinking blocks (1,1A-1N) such as first interlocking part (2) of block (1B) with second interlocking part (3) of block (1A) on a mat. while the blocks (1,1A-1N) are continually interlocked to each other and the side dimensions of the blocks are equal, thus, providing longitudinal lines shaped letter “U”, which is also a channel of grooving (5a-n).

Therefore, to insert first projecting section (6) of block (1B) with second grooved section (8) of block (1A), the first grooved part (7) below first projecting section (6) of interlinks with second projecting section (9) of the other block (1A). Since, the first interlocking part (2) interlinks with the second interlocking part (3) of the block (1,1A-1N) units, the overall shape of the interlocked blocks are solid structure like a screw type. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

The blocks (1,1A-1N) are continually interlocked to each other and the side dimensions of the blocks are equal, thus, providing longitudinal lines shaped letter “U” of the block units meets with each other to form a long channel of grooving (5a-n). These grooving (5a-n) will make the road surface look with numerous longitudinal lines.

Therefore, in a heavy rain or flooding condition, the rainwater flows in channels provided by the grooving (5a-n) and passed through the ventilation channel (4a-n) formed between the adjoining blocks (1,1A-1N).

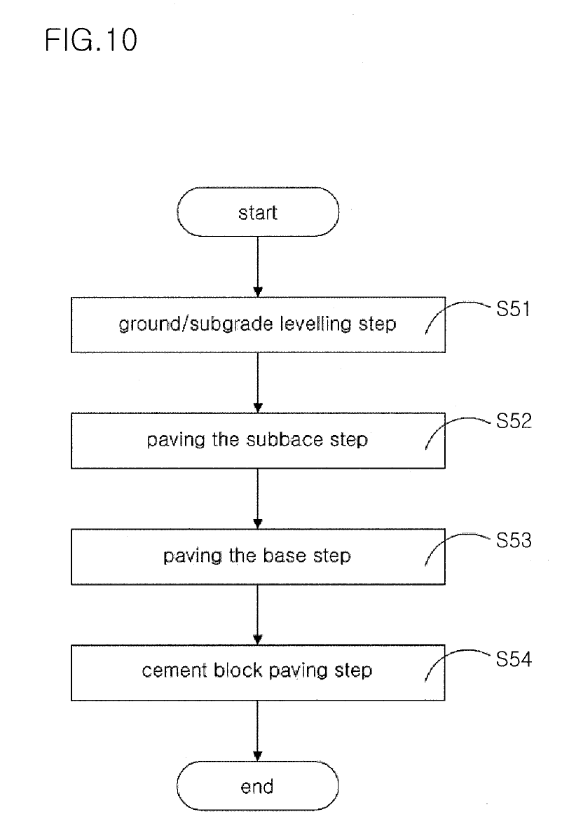

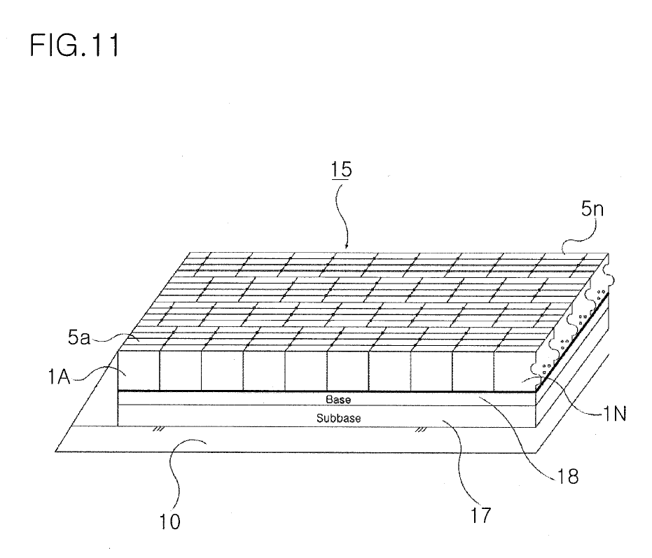

The third sample road construction method of the invention, as illustrated in FIG. 10 and FIG. 11, involves levelling the ground/subgrade step (S51). After the levelling the ground/subgrade step (S51), subbase step (S52) is proceeded, which involves compacting the coarse gravel on a prepared ground/subgrade. After the subbase step (S52), base step (S53) is proceeded, which involves compacting the fine gravel on a prepared subbase. Then, cement block paving step (S54) is proceeded, which involves continually interlinking first interlocking part to second cement block interlocking part.

One of the sample road paving methods in cement block paving step (S54) involves interlinking blocks (1,1A-1N) such as first interlocking part (2) of block (1B) with second interlocking part (3) of block (1A) on a mat. In other words, to insert first projecting section (5) of block (1B) with second grooved section (7) of block (1A), the first grooved part (6) below first projecting section (5) of first interlocking part (2) of block (1B) interlinks with second projecting section (8) of the other block (1A). Therefore, the overall shape of the interlocked blocks are solid structure like a screw. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

Therefore, the water is passed through the gaps of the blocks (1,1A-1N) and passed through the channels formed by adjoining block (1,1A-1N) units while pass through the channels provided by the ventilation channel (4a-n) and provide air circulation.

One of the sample road paving methods in cement block paving step (S54) involves interlinking blocks (1,1A-1N) such as first interlocking part (2) of block (1B) with second interlocking part (3) of block (1A) on a mat. while the blocks (1,1A-1N) are continually interlocked to each other and the side dimensions of the blocks are equal, thus, providing longitudinal lines shaped letter “U”, which is also a channel of grooving (5a-n).

Therefore, to insert first projecting section (6) of block (1B) with second grooved section (9) of block (1A), the first grooved part (7) below first projecting section (8) of interlinks with second projecting section (9) of the other block (1A). Since, the first interlocking part (2) interlinks with the second interlocking part (3) of the block (1,1A-1N) units, the overall shape of the interlocked blocks are solid structure like a screw type. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

The blocks (1,1A-1N) are continually interlocked to each other and the side dimensions of the blocks are equal, thus, providing longitudinal lines shaped letter “U” of the block units meets with each other to form a long channel of grooving (5a-n). These grooving (5a-n) will make the road surface look with numerous longitudinal lines.

Therefore, in a heavy rain or flooding condition, the rainwater flows in channels provided by the grooving (5a-n) and passed through the ventilation channel (4a-n) formed between the adjoining blocks (1,1A-1N).

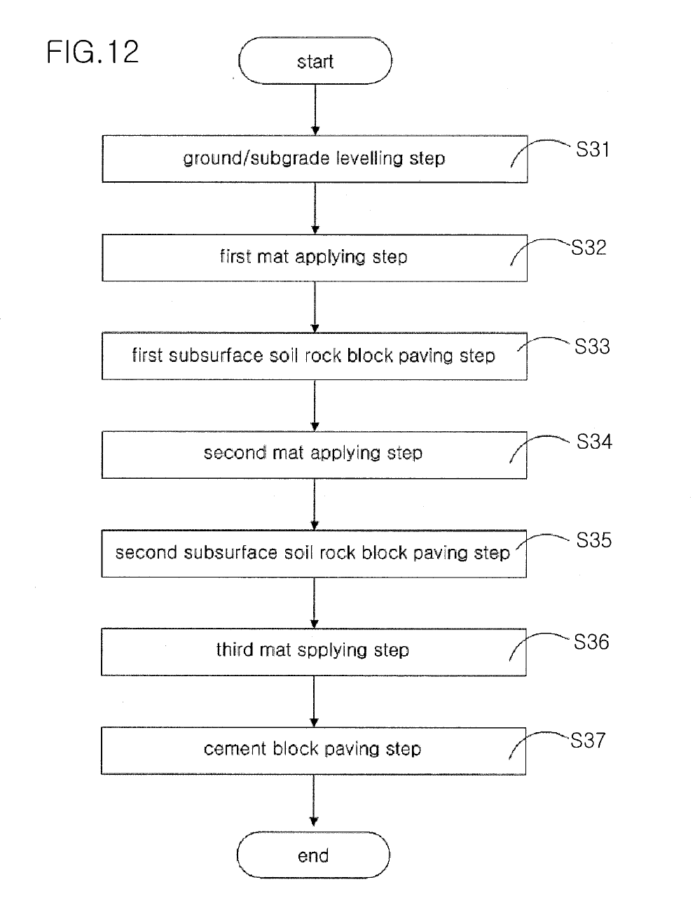

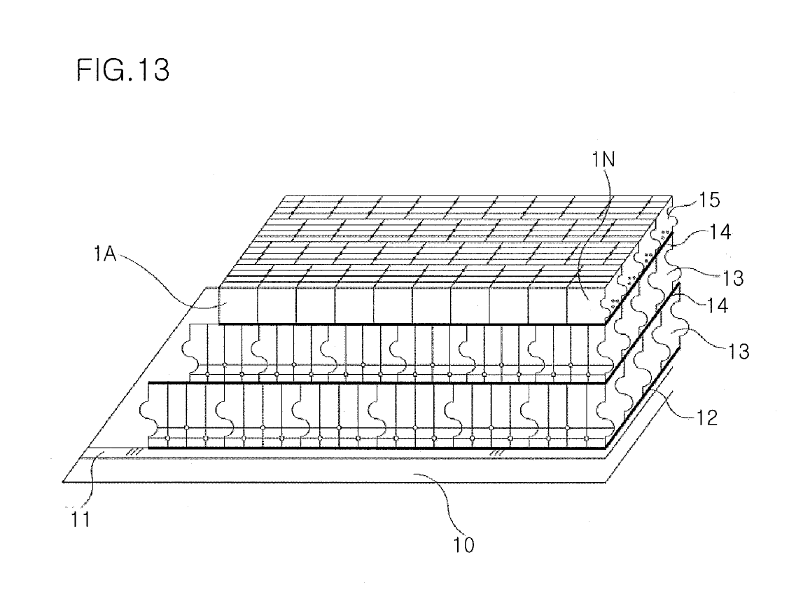

Fourth sample road construction method of the invention, as illustrated in FIG. 12 and FIG. 13, involves levelling the ground/subgrade (10) in a levelling the ground/subgrade step (S61). After the levelling the ground/subgrade step (S61), first mat applying step (S62) is proceeded, which involves covering the prepared ground/subgrade (10) with a certain type of special mat (12). On the other hand, after the first mat applying step (S62), first subsurface soil rock block paving step (S63) is proceeded, which involves continually interlinking first interlocking part to second soil rock block interlocking part of the subsurface soil rock block (13) on a prepared mat (12) in first mat applying step.

After the first subsurface soil rock block paving step (S63), second mat applying step (S64) is proceeded in order to cover the surface of the soil rock block (13) with another type of special mat (14). After the second mat applying step (S64), second subsurface soil rock block paving step (S65) is proceeded and continually interlinking first interlocking part to second interlocking part of the soil rock block (13) on a prepared second mat (14). Then, after second subsurface soil rock block paving step (S65), third mat applying step (S66) is proceeded in order to cover the surface of the soil rock block (13) with another type of special mat (14). After the thied mat applying step (S66), cement block paving step (S67) is proceeded and continually interlinking first interlocking part to second interlocking part of the cement block (15) on a prepared third mat (14).

In addition, the special type of mat (12) in first mat applying step (S62), second mat applying step (S64), and third mat applying step (S66) is PAT MAT (11) made of materials such as polyester, polymer, nylon, synthetic textile (made of material with reasonable drainage and ventilation effect).

One of the sample road paving methods in first soil rock block paving step (S63), second soil rock block paving step (S65), and cement block paving step (S67) involves interlinking blocks (1,1A-1N) such as first interlocking part (2) of block (1B) with second interlocking part (3) of block (1A) on a mat. In other block (1B) with second grooved section (7) of block (1A), the first grooved part (6) below first projecting section (5) of first interlocking part (2) of block (1B) interlinks with second projecting section (8) of the other block (1A). Therefore, the overall shape of the interlocked blocks are solid structure like a screw. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

Therefore, the water is passed through the gaps of the blocks (1,1A-1N) and passed through the channels formed by adjoining block (1,1A-1N) units while pass through the channels provided by the ventilation channel (4a-n) and provide air circulation.

One of the sample road paving methods in first soil rock block paving step (S63), second soil rock block paving step (S65), and cement block paving step (S67) involves interlinking blocks (1,1A-1N) such as first interlocking part (2) of block (1B) with second interlocking part (3) of block (1A) on a mat. while the blocks (1,1A-1N) are continually interlocked to each other and the side dimensions of the blocks are equal, thus, providing longitudinal lines shaped letter “U”, which is also a channel of grooving (5a-n).

Therefore, to insert first projecting section (5) of first interlocking part (2) of block (1B) with first grooved section (7) of block (1A), the first grooved part (7) below first projecting section (5) of interlinks with second projecting section (9) of the other block (1A). Since, the first interlocking part (2) interlinks with the second interlocking part (3) of the block (1,1A-1N) units, the overall shape of the interlocked blocks are solid structure like a screw type. Moreover, while the blocks (1,1A-1N) are continually interlocked to each other the remaining two sides without first interlocking part (2) and second interlocking part (3) has adjoining ventilation channels (4a-n) that creates a channel to drain the rainwater.

The blocks (1,1A-1N) are continually interlocked to each other and the side dimensions of the blocks are equal, thus, providing longitudinal lines shaped letter “U” of the block units meets with each other to form a long channel of grooving (5a-n). These grooving (5a-n) will make the road surface look with numerous longitudinal lines.

Therefore, in a heavy rain or flooding condition, the rainwater flows in channels provided by the grooving (5a-n) and passed through the ventilation channel (4a-n) formed between the adjoining blocks (1,1A-1N).

On the other hand, another embodyment of the invention add color to its blocks (1,1A-N) prior to be utilized on roads.

Therefore, according to the invention, roads with ventilation function can be paved to treat subterranean water, surface water, and reduce moisture. The blocks equipped with load distribution function prevents partial subsidence and roads from sinking. In addition, the gaps or joints between the blocks does not require mortar or sand filled, thus, it reduce cost and permanent drainage life. The blocks also enable flexible repair condition in the event of electricity, sewer, and telecommunication additions since blocks can be pulled out of the place and replaced back to its original position.

Furthermore, the sound drainage function of the blocks utilized on the road surface prevents hydroplaning, thus, ensures safety on roads. The blocks with drainage channels also reduces noise by absorbing and passing the sound through the lower layer. The grooving increase tire traction and prevent skidding. The blocks also create beautiful city atmosphere by adding color to its roads while decreasing temperature during hot summer season.

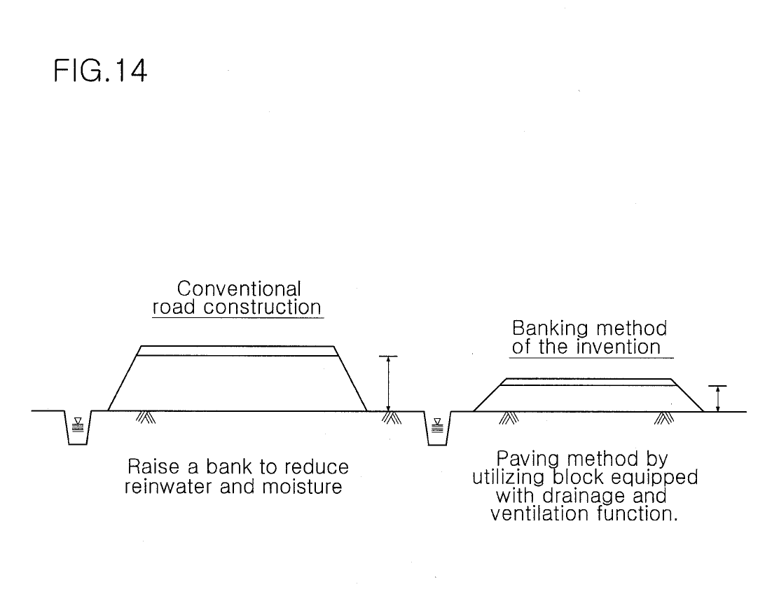

Therefore, as illustrated in FIG. 14 of the conventional pavement, the conventional road construction methods required high banking to prevent adverse effects from water and moisture. However, the invention can significantly reduce the height or thickness of banking.

### INDUSTRIAL APPLICABILITY

Unlike the past, with the improvements of lifestyles and increasing concerns about the environment the beauty aspect of the building structures as been emphasized as well as the environmentally friendly issue. In addition, there are increased concern for more advanced and improved road pavements demanding both the safety and beauty aspect in highways, bus lanes, bicycle lanes, and school zones. Among these paving methods concrete slab, asphalt, and block paving are popular. For the above methods, cement and asphalt are one of the well used materials for paving as well as the building structures.

1. Blocks equipped with drainage and ventilation functions are made of certain material, and a side of the blocks formed with first interlocking part and second interlocking part in the opposite but corresponding side while other two sides without the interlocking part formed with ventilating channels penetrating the center of the block unit.

2. The blocks as claimed in claim 1, wherein blocks are made of concrete compound material.

3. The blocks as claimed in claim 1, wherein blocks are made of soil rock compound material.

4. The blocks as claimed in claim 1, wherein blocks are made of ceramic material.

5. The blocks as claimed in claim 1, wherein blocks are made of rubber material.

6. The blocks as claimed in claim 1, wherein blocks are made of plastic material.

7. The blocks as claimed in claim 1, wherein blocks are made of polyurethane material.

8. The blocks as claimed in claim 1, wherein blocks are made of polymer material.

9. The blocks as claimed in claim 1, wherein blocks are made of petro-chemical compound material.

10. The blocks as claimed in claim 1, wherein blocks having semi-circular shaped first projecting section formed on the upper section of the first interlocking part, first grooved section located below also in a semi-circular shape, semi-circular shaped second grooved section formed on the upper section of the second interlocking part, and second projecting section located below also in a semi-circular shape.

11. Blocks equipped with drainage and ventilation functions are made of certain material, and a side of the blocks formed with first interlocking part and second interlocking part in the opposite but corresponding side while other two sides without the interlocking part formed with ventilating channels penetrating the center of the block unit and other areas without first and second interlocking parts equipped with chamfered channels in certain length and width.

12. The blocks as claimed in claim 11, wherein blocks featuring semi-circular shaped first projecting section formed on the upper section of first interlocking part and first grooved section located below also in a semi-circular shape while semi-circular shaped second grooved section formed on the upper section of second interlocking part and second projecting section located below also in a semi-circular shape.

13. The blocks as claimed in claim 11, wherein blocks are made of concrete compound material.

14. The blocks as claimed in claim 11, wherein blocks are made of soil rock compound material.

15. The blocks as claimed in claim 11, wherein blocks are made of ceramic material.

16. The blocks as claimed in claim 11, wherein blocks are made of rubber material.

17. The blocks as claimed in claim 11, wherein blocks are made of plastic material.

18. The blocks as claimed in claim 11, wherein blocks are made of polyurethane material.

19. The blocks as claimed in claim 11, wherein blocks are made of polymer material.

20. The blocks as claimed in claim 11, wherein blocks are made of petro-chemical compound material.

21. Producing method of blocks equipped with drainage and ventilation functions and made of soil rock material comprising:
screening step, which involves screening impurities from the material;
soil rock agitating step following the screening step, which involves mixing the soil rock based constituents well in a mix batch;
block forming step following the soil rock agitating step, which involves forming blocks in a steel mold utilizing the mix; and
curing step following the block forming step, which involves curing the blocks formed and producing it in a certain size.

22. The method as claimed in claim 21, wherein impurities screened in the screening step are larger than 20 mm diameter.

23. The method as claimed in claim 21, wherein soil block in the block forming step having interlocking block formed with “S” shape and number of ventilation channels formed on the internal section of the block.

24. The method as claimed in claim 21, wherein soil rock block in the block forming step having interlocking block formed with “S” shape, number of ventilation channels formed on the internal section of the block, and number of grooved lines formed at other sides of the blocks.

25. The method as claimed in claim 21, wherein a mix ratio in the soil rock agitating step consist of 85 weight % soil, 5 weight % cement, 3 weight % emulsion, and 7 weight % water.

26. Producing method of block equipped with drainage and ventilation functions comprising:
cement agitating step, which involves agitating cement mix well in a mix batch; and
cement blocks producing step following the cement agitating step, which having interlocking block formed with “S” shape and number of ventilation channels formed on the internal section of the block followed by curing the blocks.

27. The method as claimed in claim 26, wherein cement block formed by steel mold in the cement blocks producing step having interlocking block formed with “S” shape, number of ventilation channels formed on the internal section of the block, and number of grooved lines formed at other sides of the blocks.

28. Road construction method utilizing blocks equipped with drainage and ventilation functions comprising:
levelling the ground/subgrade step;
sand spreading step following the levelling the ground/subgrade step, which involves applying sandbed of a certain thickness;
first mat applying step following the sand spreading step, which involves covering the prepared sandbed with a certain type of special mat;
subsurface soil rock block paving step following the first mat applying step, which involves continually interlinking first interlocking part to second interlocking part of the subsurface soil rock block on a prepared mat;
second mat applying step following the subsurface soil rock block paving step, which involves covering the soil rock block surface with a certain type of special mat; and
cement block paving step following the second mat applying step, which involves continually interlinking first interlocking part to second interlocking part of the cement block on a prepared mat.

29. The method as claimed in claim 28, wherein mats utilization of the first mat applying step and the second mat applying step are made of polyester.

30. The method as claimed in claim 28, wherein mats utilization of the first mat applying step and the second mat applying step are made of nylon.

31. The method as claimed in claim 28, wherein mats utilization of the first mat applying step and the second mat applying step are made of polymer.

32. The method as claimed in claim 28, wherein mats utilization of the first mat applying step and the second mat applying step are made of synthetic textile.

33. The method as claimed in claim 28, wherein subsurface of the subsurface soil rock block step includes base layer, sub-base layer, and anti-frost layer.

34. The method as claimed in claim 28, further comprising:
continually interlinking blocks for both the subsurface soil rock block paving step and cement block paving step, which involves interlinking first projecting section of first interlocking part of block (1B) with second grooved section of block (1A), interlinking the first grooved part below first projecting section with second projecting section of the other block (1A) while interlocking first interlocking part with second interlocking part of the block (1,1A-1N) units, where the overall shape of the interlinked blocks are solid structure like a screw type; and the blocks (1,1A-1N) are continually interlocked to each other the remaining two sides without first interlocking part and second interlocking part has adjoining ventilation channels (4a-n) that creates a channel to drain the rainwater.

35. The method as claimed in claim 34, further comprising:
blocks (1,1A-1N) continually interlocked to each other forming a shape of screw-type in a drainage forming step and adjoining blocks with equal side dimensions providing longitudinal grooved lines on road so that the channels are formed in grooved line forming step.

36. Road construction method utilizing blocks equipped with drainage and ventilation functions comprising:
levelling the ground/subgrade step;
soil rock block paving step following the levelling the ground/subgrade step, which involves continually interlinking first interlocking part to second interlocking part of the subsurface soil rock block;
asphalt surface paving step following the soil rock block paving step, which involves completing road construction by paving asphalt surface.

37. The method as claimed in claim 36, further comprising:
continually interlinking blocks for the soil rock block paving step, which involves interlinking first projecting section of first interlocking part of block (1B) with second grooved section of block (1A), interlinking the first grooved part below first projecting section with second projecting section of the other block (1A) while interlocking first interlocking part with second interlocking part of the block (1,1A-1N) units, where the overall shape of the interlinked blocks are solid structure like a screw type; and
the blocks (1,1A-1N) are continually interlocked to each other the remaining two sides without first interlocking part and second interlocking part has adjoining ventilation channels that creates a channel to drain the rainwater.

38. The method as claimed in claim 36, further comprising: blocks (1,1A-1N) continually interlocked to each other forming a shape of screw-type in a drainage forming step and adjoining blocks with equal side dimensions providing longitudinal grooved lines on road so that the channels are formed in grooved line forming step.

39. Road construction method utilizing blocks equipped with drainage and ventilation functions comprising:
leveling the ground step that involves leveling and compaction of the subgrade/ground;
gravel spreading step followed by the levelling the ground step, which involves spreading coarse gravel base in a certain thickness with minimized voids and in an uniform manner on a prepared subgrade/ground;
base formation step followed by the gravel spreading step which involves spreading less-coarse gravel base in certain thickness with minimized voids and in an uniform manner on a prepared coarse gravel base; and,
cement block paving step which involves continually interlinking first interlocking part to second interlocking part of cement blocks on a prepared less-coarse gravel base.

40. The method as claimed in claim 39, further comprising:
continually interlinking blocks for the cement block paving step, which involves interlinking first projecting section of first interlocking part of block (1B) with second grooved section of block (1A), interlinking the first grooved part below first projecting section with second projecting section of the other block (1A) while interlocking first interlocking part with second interlocking part of the block (1,1A-1N) units, where the overall shape of the interlinked blocks are solid structure like a screw type; and
the blocks (1,1A-1N) are continually interlocked to each other the remaining two sides without first interlocking part and second interlocking part has adjoining ventilation channels that creates a channel to drain the rainwater.

41. The method as claimed in claim 39, further comprising:
blocks (1,1A-1N) continually interlocked to each other forming a shape of screw-type in a drainage forming step and adjoining blocks with equal side dimensions providing longitudinal grooved lines on road so that the channels are formed in grooved line forming step.

42. Road construction method utilizing blocks equipped with drainage and ventilation functions comprising:
levelling the ground step which involves levelling and preparing ground/subgrade;
first mat applying step following the levelling the ground step, which involves covering the prepared ground/subgrade with a certain type of special mat;
first subsurface soil rock block paving step following the first mat applying step, which involves continually interlinking first interlocking part to second interlocking part of soil rock block units on a prepared mat in first mat applying step; and
second mat applying step following the first subsurface soil rock block paving step, which involves covering the first soil rock block surface with another type of special mat;
second subsurface soil rock block paving step following the second mat applying step, which involves continually interlinking first interlocking part to second interlocking part of soil rock block units on a prepared mat in second mat applying step;
third mat applying step following the second subsurface soil rock block paving step, which involves covering the second subsurface soil rock block surface with another type of special mat; and
cement block paving step following the third mat applying step, which involves continually interlinking first interlocking part to second interlocking part of cement block units on a prepared mat in order to complete surface layer construction.

43. The method as claimed in claim 42, wherein mats utilization of the first mat applying step to the third mat applying step are made of polyester.

44. The method as claimed in claim 42, wherein mats utilization of the first mat applying step to the third mat applying step are made of nylon.

45. The method as claimed in claim 42, wherein mats utilization of the first mat applying step to the third mat applying step are made of polymer.

46. The method as claimed in claim 42, wherein mats utilization of the first mat applying step to the third mat applying step are made of synthetic textile.

47. The method as claimed in claim 42, further comprising:
continually interlinking blocks for both first and second subsurface soil rock block paving step, which involves interlinking first projecting section of first interlocking part of block (1B) with second grooved section of block (1A), interlinking the first grooved part below first projecting section with second projecting section of the other block (1A) while interlocking first interlocking part with second interlocking part of the block (1,1A-1N) units, where the overall shape of the interlinked blocks are solid structure like a screw type; and
the blocks (1,1A-1N) are continually interlocked to each other the remaining two sides without first interlocking part and second interlocking part has adjoining ventilation channels that creates a channel to drain the rainwater.

48. The method as claimed in claim 39, further comprising:
blocks (1,1A-1N) continually interlocked to each other forming a shape of screw-type in a drainage forming step and adjoining blocks with equal side dimensions providing longitudinal grooved lines on road so that the channels are formed in grooved line forming step.
